(19) United States
(12) Patent Application Publication
(10) Pub. No.: US 2006/0086398 A1
(43) Pub. Date: Apr. 27, 2006

(54) Three valve block assembly

(76) Inventor: David James Silva, San Diego, CA (US)

Correspondence Address: Serafini Associates, 7660 FAY AVE. STE H378, LA JOLLA, CA, 92037, US

(21) Appl. No.: 10/974,064

(22) Filed: Oct. 27, 2004

(51) Int. Cl. F16K 11/22

(52) U.S. Cl. 137/884

(57) ABSTRACT

A three valve block assembly is provided having three diaphragm valves, each of the valves having a diaphragm, a seat side, and a diaphragm side. In one embodiment, the diaphragm side of the first valve is juxtaposed to, and has flow communication with, the diaphragm side of the second valve and the seat side of the third valve, while the seat sides of the first and second valve and the diaphragm side of the third valve are each connected to external sources by means of individual conduits. In another embodiment, the seat sides of all three valves are juxtaposed to, and in flow communication with, each other. In yet another embodiment, the diaphragm sides of one valve and the seat sides of the other two valves are juxtaposed to, and in flow communication with, each other. In still another embodiment, the diaphragm sides of all three valves are juxtaposed to, and in flow communication with, each other.

### STATEMENT REGARDING FEDERALLY SPONSORED REASEARCH AND DEVELOPMENT

Not applicable.

### REFERENCE TO A COMPUTER LISTING, A TABLE, OR A COMPUTER PROGRAM LISTING COMPACT DISK APPENDIX

Not applicable.

### BACKGROUND OF THE INVENTION

1. Field of the Invention

The present invention concerns a three valve block assembly, and, more specifically, a three valve block assembly that is especially suitable for delivery systems of high purity chemicals.

2. Description of Related Art

Delivery systems of high purity chemicals typically employ manifolds having a plurality of diaphragm valves. For example, in the semiconductor industry, low vapor pressure high purity chemicals such as tetrakis(dymethilamino)titanium (TDMAT), tetrakis(diethylamino)titanium (TDEAT), tantalum pentaethoxide (TAETO), copper hexafluoroacetylacetonate-trimethylvinylsilane (Cu(hfac)TMVS), tetramethyltetracyclosiloxane (TMCTS), tetraethyl ortosilicate (TEOS), and trimethylphosphate (TMP) are delivered from primary storage canisters to secondary storage canisters or to process tools by means of manifolds that incorporate one or more valves regulating the flow of the chemicals during ordinary process conditions, and also regulating the flow of pressurized gases and of vacuum during purge cycles.

Often, such manifolds include two or three diaphragm valves that positioned in relative proximity of each other. It is desirable to consolidate these valves into a single, multiple-valve block assembly, in order in order to minimize the lengths of the connecting tubes, thereby reducing potential areas of entrapment or adhesion of the low vapor pressure chemical, and also to provide for more compact manifolds, thereby reducing space requirements within the cabinets where these manifolds and containers are typically situated.

U.S. Pat. No. 6,431,229 B1 to Birtcher et al. discloses a purgeable adapter manifold for low vapor pressure, high purity chemicals comprising a dual valve block assembly. This dual valve block assembly includes two diaphragm valves and a conduit that connects the seat sides of the two valves, the two seat sides being juxtaposed to each other and the two diaphragm sides instead being connected to external sources. This patent does not teach a three valve block system.

U.S. Pat. No. 6,435,229 B1 to Noah et al. discloses a bulk chemical delivery system comprising at least one manifold box, wherein each manifold box has at least two output lines. This patent application does also not teach a three valve block system.

U.S. patent application Ser. No. 10/944,364 by Silva discloses an adapter manifold for high purity chemicals having a dual valve block assembly with no dead pockets along the flow path of the chemical. This patent application does still not teach a three valve block system.

Therefore, there is a need for a three valve block assembly that may be usable within a high purity chemical delivery system.

### BRIEF SUMMARY OF THE INVENTION

A three valve block assembly is provided having three diaphragm valves, each of the valves having a diaphragm, a seat side, and a diaphragm side. In one embodiment, the diaphragm side of the first valve is juxtaposed to, and has flow communication with, the diaphragm side of the second valve and the seat side of the third valve, while the seat sides of the first and second valve, and the diaphragm side of the third valve, are each connected to external sources by means of individual conduits. In another embodiment, the seat sides of all three valves are juxtaposed to, and in flow communication with, each other. In yet another embodiment, the seat sides of two of the valves and the diaphragm side of the other valve are juxtaposed to, and in flow communication with, each other. In still another embodiment, the diaphragm sides of all three valves are juxtaposed to, and in flow communication with, each other.

It is an advantage of the present invention to provide a compact delivery system for high purity chemicals.

It is another advantage of the present invention to reduce the connection spaces between valves in a high purity chemical environment.

These and other advantages of the present invention will become apparent from a reading of the following description, and may be realized by means of the instrumentalities and combinations particularly pointed out in the appended claims.

### BRIEF DESCRIPTION OF THE SEVERAL VIEWS OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a front view of the three valve block assembly according to one embodiment of the present invention.

FIG. 2A is a first cross-section view of the embodiment of FIG. 1 illustrating portions of the first and third diaphragm valves.

FIG. 2B is a second cross-section view of the embodiment of FIG. 1 illustrating a portion of the second diaphragm valve.

### DETAILED DESCRIPTION OF THE INVENTION

Detailed descriptions of embodiments of the invention are provided herein. It is to be understood, however, that the present invention may be embodied in various forms. Therefore, the specific details disclosed herein are not to be interpreted as limiting, but rather as a representative basis for teaching one skilled in the art how to employ the present invention in virtually any detailed system, structure, or manner.

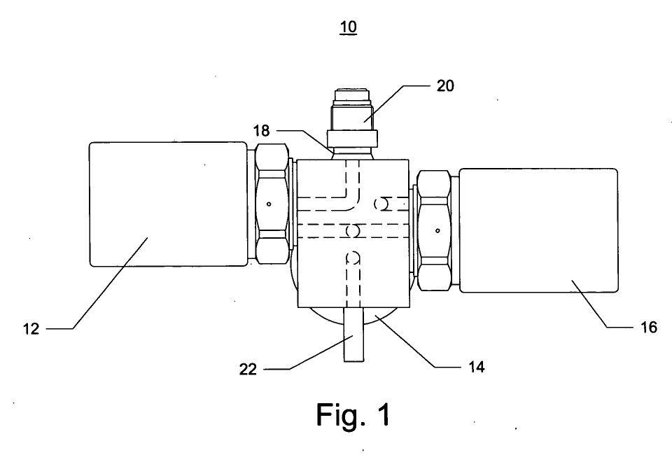

Turning first to FIG. 1, there is shown a first embodiment of the invention. A three valve block assembly 10 comprises a first diaphragm valve 12, a second diaphragm valve 14 (visible only partially), and a third diaphragm valve 16, the three diaphragm valves being interconnected as explained in detail below.

Because three valve block assembly 10 may be employed in manifolds adapted for transferring low vapor pressure high purity chemicals within a semiconductor manufacturing operation, a plurality of tubes that are suitable for transporting such chemicals, and also for transporting pressurized gases or vacuum suction during purge cycles, may extend from three valve block assembly 10. For example, a first tube 18 may connect first diaphragm valve 12 to a first external source, such as a process tool, a source of pressurized gas, or a source of vacuum. Additionally, a first low dead space connector 20, such as a fitting of the standard VCR type or a low obstruction fittings, for instance, a Fujikin's UPG gasket fitting or a Hy-Tech's Full Bore 002 fitting, may be employed to provide a detachable connection between first tube 18 and the first external source. Alternatively, first tube 18 may comprise a weld stub.

A second tube 22 may also extend from three valve block assembly 10 and connect second diaphragm valve 14 to a second external source, such as a low vapor pressure high purity container. A second low dead space connector may be employed to provide a detachable connection between second tube 22 and the second external source, or, alternatively, second tube 22 may comprise a weld stub. Additionally, a third tube (not shown) may extend from three valve block assembly 10 and connect third diaphragm valve 16 to a third external source, for instance, a source of vent. A third low dead space connector may also be employed to provide a detachable connection between the third tube and the third external source, or, alternatively, the third tube may comprise a weld stub.

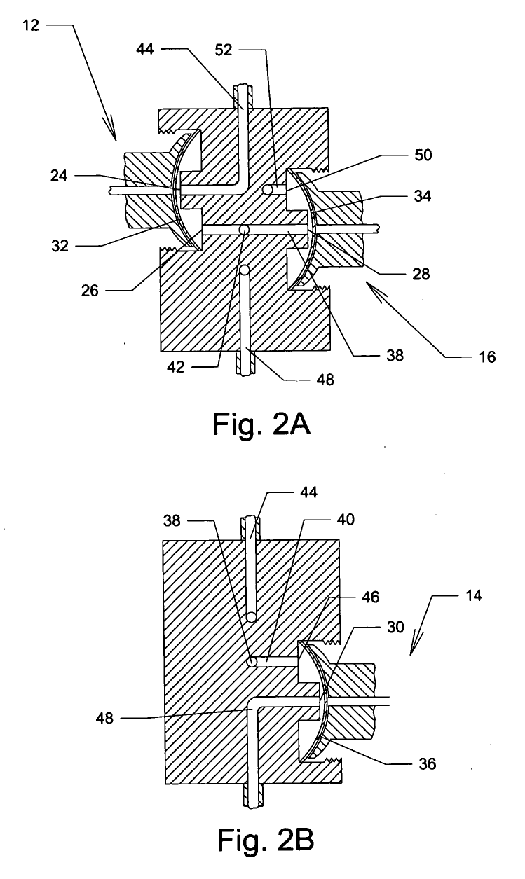

Turning now to FIGS. 2A and 2B, there are shown two different cross-section views of three valve block assembly 10, and, more specifically, there is shown in FIG. 2A a partial cross-section of first diaphragm valve 12 and of third diaphragm valve 16, and in FIG. 2B a partial cross-section view of second diaphragm valve 14.

Each of the three diaphragm valves comprises a diaphragm, a seat side, and a diaphragm side. The diaphragms of each valve are typically disks made of a flexible material, such as a flexible metal, and have a concave side and a convex side, the concave side engaging the valve seat.

In the illustrated embodiment, first seat side 24 of first diaphragm valve 12 is connected to the first external source by means of a first conduit 44, while first diaphragm side 26 of first diaphragm valve 12 is juxtaposed to, and has flow communication with, third seat side 28 of third diaphragm valve 16. Further, first seat side 24 is also juxtaposed, and has flow communication with, second diaphragm side 46 of second diaphragm valve 14.

First seat side 24 and third seat side 28 are connected by first short channel 38, while second short channel 40 provides flow communication between second diaphragm side 46 and first short channel 38 by means of aperture 42.

First diaphragm 32 of first diaphragm valve 12 engages first seat side 24, while second diaphragm 36 in second diaphragm valve 14 engages second seat side 30, and third diaphragm 34 in third diaphragm valve 16 engages third seat side 28. These diaphragms may be actuated manually, pneumatically, or electrically with a solenoid.

At the same time, second seat side 30 of second diaphragm valve 14 is connected to the second external source by means of a second conduit 48, while third diaphragm side 50 of third diaphragm valve 16 is connected to the third external source by means of a third conduit 52.

In a second embodiment (not shown), first short channel 38 connects first seat side 24 to third seat side 28, while second short channel 40 connects second seat side 30 to first short channel 38. Therefore, in this embodiment, all seat sides are juxtaposed to, and in flow communication with, each other, while each of the diaphragm sides is connected to an external source by means of individual conduits.

In a third embodiment (not shown), first short channel 38 connects first diaphragm side 26 to third seat side 28, while second short channel 40 connects second seat side 30 to first short channel 38. Therefore, in this embodiment, first diaphragm side 26, second seat side 30, and third seat side 28 are juxtaposed to, and in flow communication with, each other, while first seat side 24, second diaphragm side 46, and third diaphragm side 50 are each connected to an external source by means of individual conduits.

In a fourth embodiment (not shown), first short channel 38 connects first diaphragm side 26 and third diaphragm side 50, while second short channel 40 connects second diaphragm side 46 to first short channel 38. Therefore, in this embodiment, all three diaphragm sides are juxtaposed to, and in flow communication with, each other, while each of the seat sides is connected to an external source by means of individual conduits.

While the invention has been described in connection with the above described embodiment, it is not intended to limit the scope of the invention to the particular forms set forth, but on the contrary, it is intended to cover such alternatives, modifications, and equivalents as may be included within the scope of the invention.

1. A three valve block assembly comprising:
a first diaphragm valve having a first diaphragm, a first seat side, and a first diaphragm side;
a second diaphragm valve having a second diaphragm, a second seat side, and a second diaphragm side; and
a third diaphragm valve having a third diaphragm, a third seat side and a third diaphragm side,
wherein the first diaphragm side is juxtaposed to, and has flow communication with, the second diaphragm side and the third seat side, and
wherein a first conduit provides flow communication between the first seat side and a first external source, a second conduit provides flow communication between the second seat side and a second external source, and a third conduit provides flow communication between the third diaphragm side and a third external source.

2. The three valve block assembly of claim 1, further comprising:
a first tube for detachably connecting the first seat side to the first external source;
a second tube for detachably connecting the second seat to the second external source; and
a third tube for detachably connecting the third diaphragm side to the third external source,
wherein each of the tubes extends form the block assembly, and
wherein each of the tubes is suitable for transferring a low vapor pressure high purity chemical, a pressurized gas, and vacuum suction.

3. A three valve block assembly comprising:
a first diaphragm valve having a first diaphragm, a first seat side, and a first diaphragm side;
a second diaphragm valve having a second diaphragm, a second seat side, and a second diaphragm side; and
a third diaphragm valve having a third diaphragm, a third seat side and a third diaphragm side,
wherein the first seat side is juxtaposed to, and has flow communication with, the second and third seat sides, and
wherein a first conduit provides flow communication between the first diaphragm side and a first external source, a second conduit provides flow communication between the second diaphragm side and a second external source, and a third conduit provides flow communication between the third diaphragm side and a third external source.

4. The three valve block assembly of claim 3, further comprising:
a first tube for detachably connecting the first diaphragm side to the first external source;
a second tube for detachably connecting the second diaphragm side to the second external source; and
a third tube for detachably connecting the third diaphragm side to the third external source,
wherein each of the tubes extends form the block assembly, and
wherein each of the tubes is suitable for transferring a low vapor pressure high purity chemical, a pressurized gas, and vacuum suction.

5. A three valve block assembly comprising:
a first diaphragm valve having a first diaphragm, a first seat side, and a first diaphragm side;
a second diaphragm valve having a second diaphragm, a second seat side, and a second diaphragm side; and
a third diaphragm valve having a third diaphragm, a third seat side and a third diaphragm side,
wherein the first diaphragm side is juxtaposed to, and has flow communication with, the second and third seat sides, and
wherein a first conduit provides flow communication between the first seat side and a first external source, a second conduit provides flow communication between the second diaphragm side and a second external source, and a third conduit provides flow communication between the third diaphragm side and a third external source.

6. The three valve block assembly of claim 5, further comprising:
a first tube for detachably connecting the first conduit to the first external source;
a second tube for detachably connecting the second conduit to the second external source; and
a third tube for detachably connecting the third conduit to the third external source,
wherein each of the tubes extends form the block assembly, and
wherein each of the tubes is suitable for transferring a low vapor pressure high purity chemical, a pressurized gas, and vacuum suction.

7. A three valve block assembly comprising:
a first diaphragm valve having a first diaphragm, a first seat side, and a first diaphragm side;
a second diaphragm valve having a second diaphragm, a second seat side, and a second diaphragm side; and
a third diaphragm valve having a third diaphragm, a third seat side and a third diaphragm side,
wherein the first diaphragm side is juxtaposed to, and has flow communication with, the second and third diaphragm sides, and
wherein a first conduit provides flow communication between the first seat side and a first external source, a second conduit provides flow communication between the second seat side and a second external source, and a third conduit provides flow communication between the third seat side and a third external source.

8. The three valve block assembly of claim 1, further comprising:
a first tube for detachably connecting the first seat side to the first external source;
a second tube for detachably connecting the second seat side to the second external source; and
a third tube for detachably connecting the third seat side to the third external source,
wherein each of the tubes extends form the block assembly, and
wherein each of the tubes is suitable for transferring a low vapor pressure high purity chemical, a pressurized gas, and vacuum suction.
